(19) United States
(12) Patent Application Publication
(10) Pub. No.: US 2008/0082694 A1
(43) Pub. Date: Apr. 3, 2008

(54) DATA FILE TRANSMISSION METHOD AND DEVICE

(75) Inventors: Henri LABBE, Croix (FR); Michel SAVIDAN, La Seyne Sur Mer (FR); Alain BRODU, Ploumoger (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 11/851,756

(22) Filed: Sep. 7, 2007

(30) Foreign Application Priority Data
Sep. 8, 2006 (FR) 0607884

(51) Int. Cl. G06F 15/16

(52) U.S. Cl. 709/247

(57) ABSTRACT

The present invention relates to a data file transmission method and device using a low-rate data link. The method comprises the steps of selecting the data file to be transmitted, compressing the initial file data, converting the compressed file data into a data format compliant with a protocol specific to the data link, composing messages comprising the file data converted in the preceding step and the type of the initial data, and sending the messages, via a transmission means, over the low-rate data link.

### RELATED APPLICATIONS

The present application is based on, and claims priority from, France Application Number 0607884, filed Sep. 8, 2006, the disclosure of which is hereby incorporated by reference herein in its entirety.

### BACKGROUND OF THE INVENTION

The present invention relates to a method and a device for transmitting data files in particular via long-range and low-rate radio transmissions. These transmissions are used, for example, to transmit information from a moving element, which can be an aircraft, to a ground station.

### DESCRIPTION OF THE PRIOR ART

In an aircraft reconnaissance mission, the data and information that it has collected cannot be analyzed before the aircraft has returned to the ground. The same generally applies for a ship. Most aircraft have no equipment with which to transmit large-size data such as photos or text documents. To overcome this drawback, one solution would be to equip the mobiles and the ground stations with satellite transmission equipment. However, the equipment to be used is costly to deploy and, because of its size, complicated to implement, particularly on board aircraft given the little space available.

### SUMMARY OF THE INVENTION

One aim of the invention is, in particular, to overcome the abovementioned drawbacks. To this end, the subject of the invention is a method of transmitting large-size data files compared to the transmission capacity of a low-rate data link.

The inventive method can comprise at least the following steps:
a first step for selecting the data file to be transmitted,
a second step for compressing the initial file data,
a third step for converting the compressed file data into a data format compliant with a protocol specific to the data link,
a fourth step for composing messages comprising the file data converted in the preceding step and the initial data type,
a fifth step for sending the messages, via a transmission means, over the low-rate data link.
   The method can also comprise a phase for receiving the messages sent comprising the following steps:
a first step for identifying the initial data type contained in the messages,
a second step for reconstructing the data file from the messages received.
   The file reception phase can also comprise a step for decompressing the data received according to the initial data type.

The low-rate data link used for the method according to the invention can be a telegraphic link.

The transmission and reception of the data can use the ACP 127 transmission protocol. The messages are then constructed in accordance with the ACP 127 transmission protocol and by converting the compressed file data into characters in the ASCII format. The data converted to the ASCII format is then converted into data compatible with the BAUDOT format when the messages are constructed. The transmission method can also comprise a step for an additional compression of the file data according to the ASCII or BAUDOT transmission format.

Each message sent may, if necessary, include an indication as to the validity of the data contained in the message. This validity indication is checked when the message is received.

The transmission method comprises a step for recomposing the received messages.

The device for transmitting large-size data files comprises, on the one hand, means of sending messages over a low-rate data link and, on the other hand, means of receiving the messages sent. The sending and receiving means comprise at least the following elements:
a means of transmitting messages to the data link,
a means of constructing messages and of reconstructing the file data comprising a module using the inventive method.

### BRIEF DESCRIPTION OF THE DRAWINGS

Other characteristics and advantages of the invention will become apparent from the illustrative and nonlimiting description that follows, given in light of the appended drawings which represent:

FIG. 1, an example of transmission of a photograph using the inventive method;

FIG. 2, a diagrammatic view of the transmission chain using the inventive method;

FIG. 3, an example of implementation of a photograph transmission using the inventive method;

FIG. 4, the steps of the file transmission inventive method;

FIG. 5, a diagrammatic description of the message format enabling a file to be transmitted using the inventive method.

### DETAILED DESCRIPTION

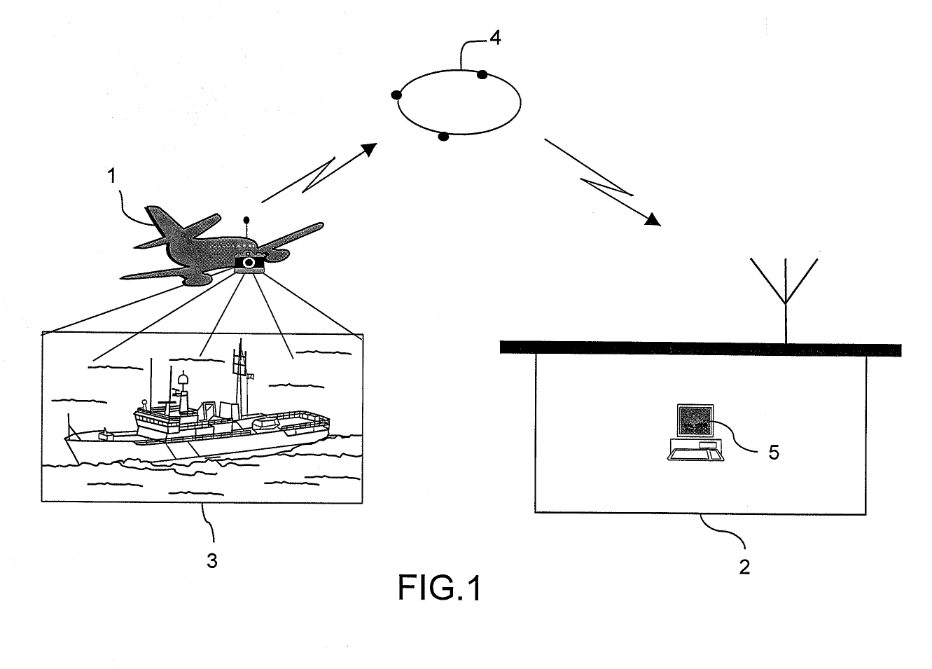

FIG. 1 represents an example of transmission of a data file from an airplane 1 to a ground station 2. In this example, a reconnaissance airplane takes a photograph 3 of a boat. This photograph 3 must be transmitted to the ground station 2 while the airplane is still flying.

The ground stations mostly have only a very long range telegraphic-type network link 4, having a very low bit rate, enabling them to communicate securely with other ground stations or even with mobile. These telegraphic communications can be used to convey brief information such as textual instructions.

The invention relies in particular on a shrewd adaptation of a telegraphic transmission equipment, that exists for ships, to use for an aircraft. The telegraphic transmission equipment comprises in particular a module using the inventive method, described later, making it possible to transmit messages typically containing the photograph 3 in the form of telegraphic messages.

In order to better understand the invention, an exemplary embodiment is given for equipment that makes it possible to use telegraphic messages according to a standard transmission protocol: ACP 127. This transmission protocol is used to transmit telegraphic-type messages over a dedicated network. The ACP 127 protocol is notably described in a document entitled “ACP 127 US SUPP-1 (J)” that can be accessed at the Internet address: http://www.jcs.mil/j6/eb/acps/.

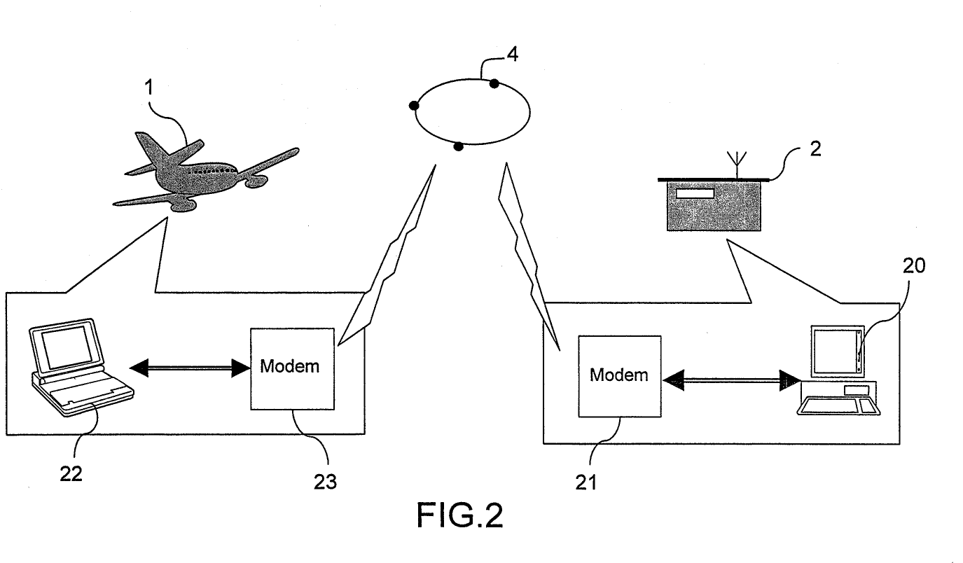

FIG. 2 represents an exemplary implementation of a link via a telegraphic network 4 using the ACP 127 transmission protocol. The ground station 2 has equipment 20 for processing telegraphic messages and managing communication protocols. The equipment 20 comprises a module for sending and receiving telegraphic messages using the inventive method which will be described later. Once composed, the messages pass through a modem 21 responsible for sending the messages over the telegraphic network 4 and for receiving the messages from the telegraphic network 4. As for the airplane 1, this is equipped in the same way as the ground station 2, except that data link management equipment are adapted to the conditions of implementation on board the airplane 1. This equipment comprises in particular a portable station 22 for processing the telegraphic messages in transmit and receive modes, and for managing the communication protocol. The portable station 22 comprises in particular a module for sending and receiving telegraphic messages using the inventive method described hereinafter. The airplane 1 also has a modem 23 enabling it to transmit the messages to the telegraphic network 4.

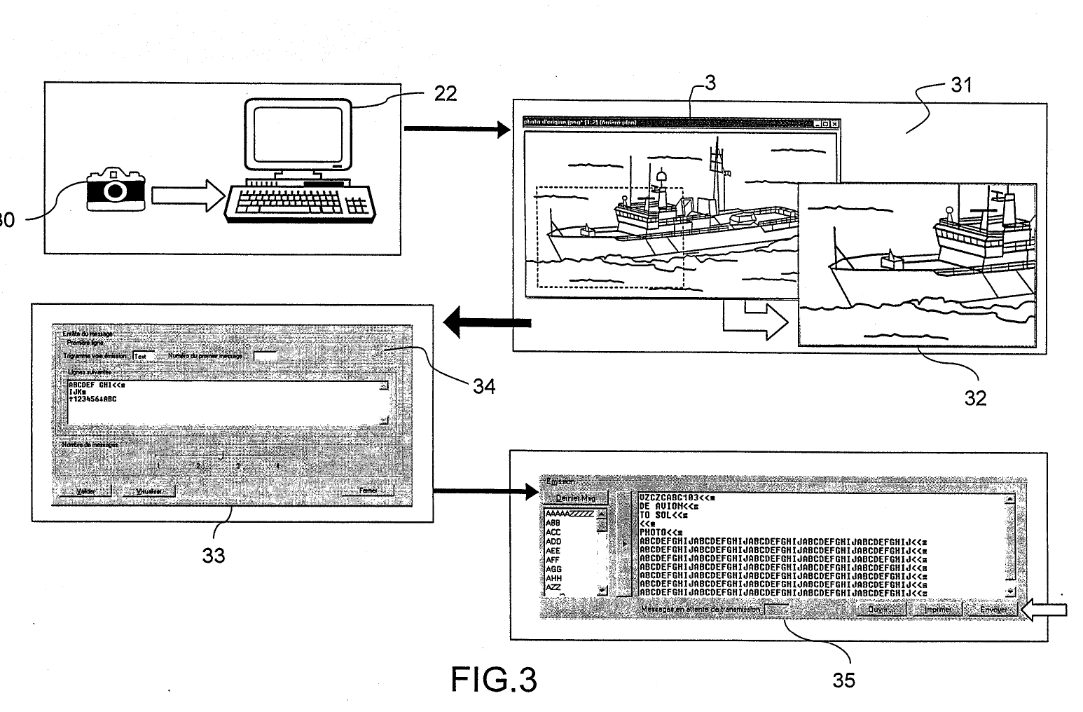

FIG. 3 shows an example of transmission of a large-size data file via a telegraphic link 4. For example, when an operator takes a photograph 3 using a digital camera 30 on board the airplane 1, he can transfer it to a laptop computer 22 via conventional means such as a memory card reader not shown in FIG. 3. He can then, in a second stage, perform a redimensioning operation 31 on the original photo 3 in order to retain only the useful part of the original photograph 3: the result of this is the image 32. The size of the file containing the image is thus reduced. The operator can then compose a message according to the ACP 127 protocol enabling him to send the image 32 to a ground station 2. To compose the message, the operator uses a man/machine interface 33 to input a message header 34 specifying in particular a recipient, a message number and a date. He then selects the number of messages that he wants in order to send the file describing the image 32. The operator can view the image 32 before it is sent, the latter having previously been compressed, using the inventive method described below. In practice, since the size of a message is limited, the size of the data describing the image must be reduced to the minimum so that the image can be entirely contained in the number of messages defined by the operator. If the quality of the image to be sent is not visually satisfactory, the operator can increase the number of messages used to send the image 32. In practice, the more messages used, the less the image will be compressed, and the better the quality will therefore be. Once the optimum number of messages has been found, the messages comprising the image are composed automatically. The image is therefore divided into as many parts as there are messages required to send it, each message comprising a part of the image. The set of messages therefore comprises all the parts of the image. The composed messages can be viewed by the operator on a man/machine interface 35. The operator must then click the “Send” button in order for the messages to be transmitted via the telegraphic network 4, to the ground station 2.

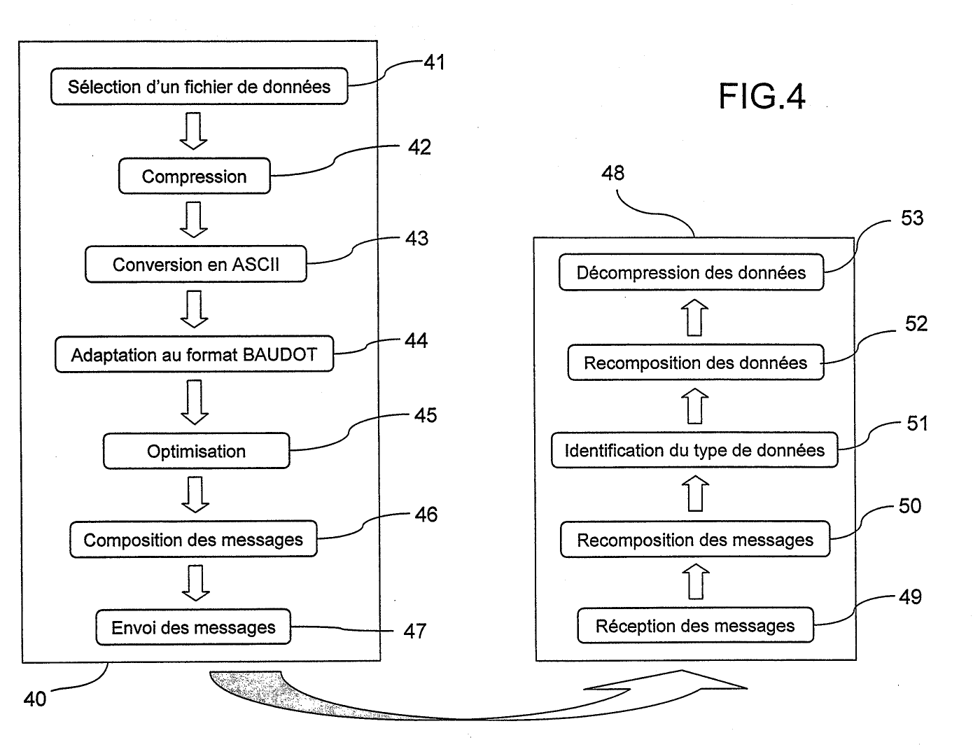

FIG. 4 describes an example of steps used by the method of transmitting a data file according to the invention. The transmission method comprises a first phase 40 for sending the data, for example, from the airplane 1, and a second phase 48 for the reception of this data by the ground station 2.

The sending of the data comprises a first step 41 for selecting a data file to be sent.

Once the file has been selected, the next step consists in compressing the data contained in the file to be sent. This compression step 42 is used to limit the number of messages used to send the data file. This provides a way of reducing the time it takes to transmit the data file. This step can comprise a first compression performed by an operator which consists, for example, in reducing the quantity of data contained in the file such as by redimensioning an image. A software compression of the data can also be added. To this end, it is possible to use a specific image compression format or even data compression software known to those skilled in the art. Once the data is compressed, it is in the form of binary data.

This binary data is, during a third step 43, converted into data in the ASCII format. The ASCII (American Standard Code for Information Interchange) format is used to encode characters in computer language. Each character of an ASCII text is stored on one byte, or eight bits. One byte of binary file data, taken in hexadecimal form, is converted into two ASCII characters chosen, for example, from the following characters: “013456789ABCDEF”. For example, by using this character set, a byte “0x3F” is converted into “3” and “F”. This therefore makes it possible to obtain a data file comprising only characters accepted by the data format used by the ACP 127 protocol.

A fourth step 44 converts the data into a format suitable for transmission in BAUDOT code. The BAUDOT code is a binary telegraphic code for which each character is encoded on five bits. The ACP 127 protocol makes it possible to send messages in this particular format. It is therefore necessary, if messages that are to be sent in the BAUDOT format, to adapt the format of the data to the specifics of this format. An adaptation may consist in converting the character set “013456789ABCDEF” into a character set “ABCDEFGHIJKLMOPQ”. The characters “3F” then become “DQ” on conversion. The conversion applied makes it possible to encode the file data in the BAUDOT format by using only letters in order to avoid adding an additional control character which is imposed by the BAUDOT format when changing from a letter to a digit in the message. Thus, the size of the message is not increased when data is converted to the BAUDOT format.

A fifth step 45 can be added to optimize the size of the data stored in each message. This optimization uses the fact that the encoding, described above using 16 character types, uses only four of the five bits that can be used in BAUDOT format. One optimization therefore consists in using the five bits to store the maximum quantity of data in a message sent in the BAUDOT format. Another optimization for the messages sent in ASCII consists, for example, in using the six bits of an ASCII character instead of the four bits used previously to encode the sixteen types of characters used. These optimizations advantageously make it possible to reduce the size of the data transmitted and therefore the number of messages used.

A sixth step 46 can be used to compose the messages according to the ACP 127 protocol.

A seventh step 47 is a step for the transmission of the messages to the telegraphic network 4 by the existing transmission equipment. Each message is sent several times in order to guarantee the integrity of the data on reception.

Once the messages have been sent, they are received by a ground station 2 during an eighth step 49. Several occurrences of the same message are received.

The original message is then recomposed, in a ninth step 50, from the various occurrences received. This step is applied to each of the messages received.

A tenth step 51 is used to identify the type of data contained in the message.

This makes it possible to adapt the subsequent processing operation 52 for recomposing the data according to the type of data received. In practice, the processing operations are suited to the type of original data contained in the file. These processing operations are used to convert the data received, for example, into ASCII or BAUDOT format and then into binary data according to the same method as that used to convert the file data.

Then, depending on the type of data, it can be decompressed during a decompression step 53 or directly stored in a file of a type corresponding to the type of data sent.

This method thus makes it possible to convey files containing large quantities of data via a low-rate telegraphic transmission network and have good quality data on reception.

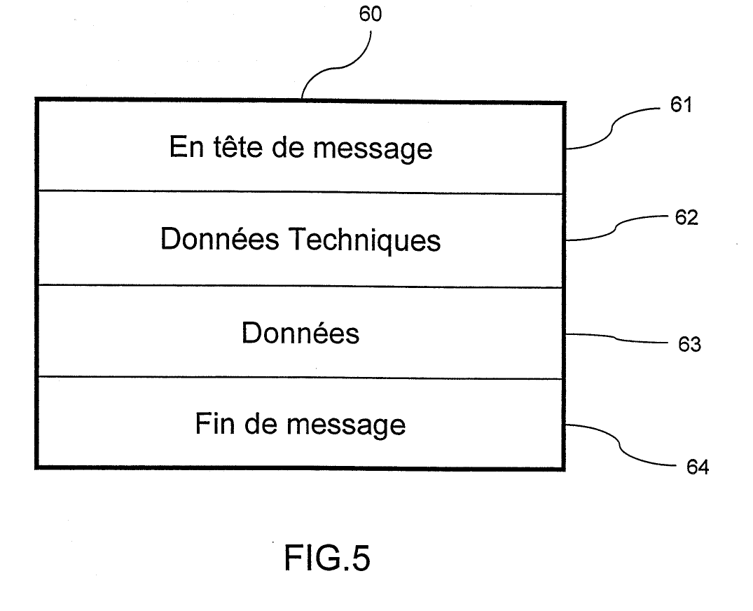

FIG. 5 diagrammatically represents the structure 60 of a telegraphic message according to the ACP 127 protocol. It should be noted that the structure shown is generic enough to satisfy the needs of other telegraphic communication protocols. The structure of a telegraphic message comprises, for example, four parts:
a first part 61 can be a header of the message. This header 61 is used to identify the message concerned. A message header typically comprises the identifier of the sender of the message, the recipient and the level of confidentiality of the message. The header 61 can be composed manually by the operator.
The message can also comprise a second part 62 containing technical data used in particular to identify and number the messages, identify the type of data contained in the message and check the integrity of the data contained in the message.
The message also comprises a third part 63 containing useful data in which the converted characters representing the file data to be sent are stored.
Then, the message comprises a fourth part 64 indicating the end of the message.
   This message structure can be used to convey both information in text form and data converted to the form of a string of textual characters as is the case for the inventive method.

The inventive method makes it possible to transfer any type of file, provided that the file can be converted into a binary data file. It is therefore possible in particular to use the inventive method to transmit text documents, presentations and sound files.

The method can be implemented by any type of station or mobile wanting to send large-size data files via a low-rate telegraphic link.

The steps of the inventive method that involve performing file data compressions or transformations can use principles other than those described depending on the type of data to be transmitted.

The inventive method makes it possible advantageously to reuse the communication hardware and existing low-rate data links to be able to convey large-size data files between two stations, whether mobile or not. The inventive method is therefore inexpensive and simple to implement.

The inventive method also makes it possible to reduce the size of the data to be transmitted in order to reduce the message transmission times.

1. A data file transmission method using a low-rate data link and comprising:
selecting the data file to be transmitted,
compressing the initial file data,
converting the compressed file data into a data format compliant with a protocol specific to the data link,
composing messages, each message comprising a part of the file data converted in the preceding step and the initial data type, and
sending the messages, via a transmission means, over the low-rate data link.

2. The method as claimed in claim 1, comprising a phase for receiving the messages sent comprising:
identifying the initial data type contained in the messages,
reconstructing the data file from the messages received.

3. The method as claimed in claim 1, wherein the reception of the file comprises decompressing the data received according to the initial data type.

4. The method as claimed in claim 1, wherein the low-rate data link is a telegraphic link.

5. The method as claimed in claim 1, wherein, the transmission and reception of the data using the ACP 127 transmission protocol, the messages are constructed in accordance with the ACP 127 transmission protocol and by converting the compressed file data into characters in the ASCII format.

6. The method as claimed in claim 5, wherein the data converted to the ASCII format is converted into data compatible with the BAUDOT format when the messages are constructed.

7. The method as claimed in claim 1, wherein the transmission comprises an additional compression of the file data according to the ASCII or BAUDOT transmission format.

8. The method as claimed in claim 1, wherein each message sent includes an indication as to the validity of the data contained in the message, this validity indication being checked when the message is received.

9. The method as claimed in claim 1, wherein the transmission comprises recomposing the received messages.

10. A data file transmission device comprising:
means of sending messages over a low-rate data link and,
means of receiving the messages sent, said sending and receiving means comprising the following elements:
means for transmitting messages to the data link,
means for constructing the messages and for reconstructing the file data comprising a module configured for:
selecting the data file to be transmitted,
compressing the initial file data,
converting the compressed file data into a data format compliant with a protocol specific to the data link,
composing messages, each message comprising a part of the file data converted in the preceding step and the initial data type, and
sending the messages, via a transmission means, over the low-rate data link.
